(19) United States
(12) Patent Application Publication
(10) Pub. No.: US 2008/0285807 A1
(43) Pub. Date: Nov. 20, 2008

(54) Apparatus for Recognizing Three-Dimensional Motion Using Linear Discriminant Analysis

(76) Inventors: Jae-Ho Lee, Daejon (KR); Chang-Joon Park, Daejon (KR); In-Ho Lee, Daejon (KR); Hyun-Bin Kim, Daejon (KR)

Correspondence Address: STAAS & HALSEY LLP, SUITE 700, 1201 NEW YORK AVENUE, N.W., WASHINGTON, DC, 20005, US

(21) Appl. No.: 12/091,625

(22) PCT Filed: Dec. 5, 2006
(86) PCT No.: PCT/KR2006/005203

§ 371 Date: Apr. 25, 2008

(30) Foreign Application Priority Data
Dec. 8, 2005 (KR) 10-2005-0120061
Feb. 1, 2006 (KR) 10-2006-0009840

(51) Int. Cl. G06T 1/00

(52) U.S. Cl. 382/107

(57) ABSTRACT

Provided is an apparatus and method for recognizing a three-dimensional (3D) motion using Linear Discriminant Analysis (LDA). The apparatus includes: a 3D motion capturing means for creating motion data for every motion; a motion recognition learning means for analyzing the created motion data, creating a linear discrimination feature component for discriminating corresponding motion data, extracting/storing a reference motion feature, and recognizing each of the extracted/stored reference motion features as a corresponding motion; and a motion recognition operating means for extracting a motion feature from motion data, searching a reference motion feature corresponding to the extracted input motion feature, and recognizing a motion corresponding to the searched reference motion feature as a 3D motion.

### TECHNICAL FIELD

The present invention relates to an apparatus and method for recognizing a three-dimensional (3D) motion using Linear Discriminant Analysis (LDA); and, more particularly, to an apparatus and method for recognizing a three-dimensional motion using the LDA which provides easy interaction between a human being and a system in a 3D motion application system such as a 3D game, virtual reality, and a ubiquitous environment easy and provides an intuitive sense of absorption by analyzing motion data following many types of motions by using the LDA, creating a linear discrimination feature based, extracting/storing a reference motion feature component on the created linear discrimination feature component, and searching a reference motion feature corresponding to a feature of a 3D input motion to be recognized among the extracted/stored reference motion features.

### BACKGROUND ART

Conventional motion recognition technologies include a motion recognition technology using a portable terminal, a motion recognition technology using an infrared rays reflector, a motion recognition technology using a two-dimensional (2D) image. Each conventional technology will be described in brief and their problems will be considered.

The motion recognition technology using the conventional portable terminal is a technology for recognizing a motion based on a mechanical signal from the portable terminal and transmitting a recognized command. The object of the motion recognition technology using the conventional portable terminal is to transmit a command of a human being without manipulating buttons of the portable terminal by sensing a motion pattern of a hand holding the portable terminal. However, there is a problem that it is difficult to recognize a three-dimensional (3D) motion of a human being by the conventional technology, which can control only a simple motion of a device by attaching an acceleration sensor.

Another conventional motion recognition technology using an infrared rays reflector as an input signal includes a technology which can substitute for an interface of a mouse or a pointing device. An object of the motion recognition technology is to recognize a gesture of a hand by generating infrared rays toward the hand in an infrared rays generation device and processing an infrared rays image reflected in an infrared rays reflector thimble of the hand. However, since the conventional technology requires the infrared rays reflector, the infrared rays generation device, and the image acquisition device, there is a problem that it increases a cost. Although there is a merit that the conventional technology can grasp an exact optical characteristic of a feature point, it is difficult to recognize an entire motion of the human being.

Another conventional motion recognition technology using 2D image includes a technology for classifying motions by the 2D image by recognizing motions based on 2D feature points and creating a key code for the classified motions. The object of the motion recognition technology using the conventional 2D image is to recognize a 2D motion by extracting a feature point fixed in the 2D image and recognizing the motion based on the extracted feature point. The conventional technology is used to a device to which the 2D motion recognition is applied. However, there is a problem that the conventional technology is not applied to a field such as a 3D game or virtual reality in which the 3D motion is applied.

### DISCLOSURE

### Technical Problem

It is, therefore, an object of the present invention to provide an apparatus and method for recognizing a three-dimensional (3D) motion using Linear Discriminant Analysis (LDA) which provides easy interaction between a human being and a system in a 3D motion application system such as a 3D game, virtual reality, and a ubiquitous environment and provides an intuitive sense of absorption by analyzing motion data following many types of motions by using the LDA, creating a linear discrimination feature component, extracting/storing a reference motion feature based on the created linear discrimination feature component, and searching a reference motion feature corresponding to a feature of a 3D input motion to be recognized among the extracted/stored reference motion features.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### Technical Solution

In accordance with one aspect of the present invention, there is provided an apparatus for recognizing a three-dimensional (3D) motion using Linear Discriminant Analysis (LDA), including: a 3D motion capturing means for creating motion data for every motion by using a marker-free motion capturing process for human actor's motion; a motion recognition learning means for analyzing the created motion data on multiple types of motions using the LDA, creating a linear discrimination feature component for discriminating corresponding motion data, extracting/storing a reference motion feature on each type of motions based on the created linear discrimination feature component, and recognizing each of the extracted/stored reference motion features as a corresponding motion; and a motion recognition operating means for extracting a motion feature based on the created linear discrimination feature component from motion data on an input motion to be the created 3D recognition object, searching a reference motion feature corresponding to the extracted input motion feature among the stored reference motion features, and recognizing a motion corresponding to the searched reference motion feature as a 3D motion on the input motion.

The apparatus further includes: a motion command transmitting means for transmitting the recognized 3D motion to a motion command of a character; a key input creating means for creating a key input value corresponding to the transmitted motion command transmitted from the motion command transmitting means; and a 3D virtual motion controlling means for controlling a 3D virtual motion of the character according to the created key input value.

In accordance with another aspect of the present invention, there is provided a method for recognizing a three-dimensional (3D) motion using Linear Discriminant Analysis (LDA), including the steps of: a) creating motion data for every motion by performing a marker-free motion capturing process on a motion of an actor; b) extracting a motion feature based on a pre-stored linear discrimination feature component from motion data on an input motion, which is an object of 3D recognition created in the step a); c) searching a reference motion feature, which has the minimum statistical distance from the extracted input motion feature, among the pre-stored reference motion features; and d) recognizing a motion corresponding to the searched reference motion feature as a 3D motion corresponding to the input motion.

The method further includes the steps of: e) creating and storing the linear discrimination feature component for discriminating the motion data by analyzing the created motion data on multiple motions using the LDA; f) extracting and storing a reference motion feature on each type of motions based on the created linear discrimination feature component generated in the step e); and g) recognizing each of extracted/stored reference motion features as a corresponding motion.

The method further includes the steps of: h) transmitting the 3D motion recognized in the step d) to a motion command of a character; i) creating a key input value corresponding to the transmitted motion command; and j) controlling a 3D virtual motion of the character according to the created key input value.

The object of the present invention is to provide 3D motion recognition which can provide easy interaction between a human being and a computer for a 3D motion and provide an intuitive sense of absorption for the 3D motion inputted in real-time by recognizing a motion of the human being in real-time by using the LDA and applying the recognized motion to a 3D application system.

Accordingly, procedures of analyzing motion data on many types of motions by using the LDA, creating a linear discrimination feature component, extracting/storing a reference motion feature component on the created feature component, and searching a reference motion feature corresponding to a feature of a 3D input motion to be recognized among the extracted/stored reference motion features.

### ADVANTAGEOUS EFFECTS

The present invention can remove a difficulty that a typical motion input devices should have a marker by learning many types of motions based on marker-free motion capture and Linear Discriminant Analysis (LDA). Also, the present invention can improve applicability of a three-dimensional (3D) system and exactly recognize a motion of a human being required for an application system such as a 3D game, virtual reality, and a ubiquitous environment in real-time.

The present invention can provide an efficient and intuitive sense of absorption by transmitting the recognition result to an actual application in real-time for direct determination of a user and smoothly apply an interface between a human being and a computer.

The present invention can be applied to diverse fields such as education, sports and entertainment. It is also possible to realize a 3D motion recognition system of a low cost using a web camera through the present invention. That is, the present invention can be applied through a simple device at home.

### DESCRIPTION OF DRAWINGS

The above and other objects and features of the present invention will become apparent from the following description of the preferred embodiments given in conjunction with the accompanying drawings, in which:

FIG. 1 shows an apparatus for recognizing a three-dimensional (3D) motion using Linear Discriminant Analysis (LDA) in accordance with an embodiment of the present invention;

FIG. 2 is a block diagram illustrating a motion recognition learning/operating block and a 3D motion applying block of FIG. 1;

FIGS. 3 and 4 show a conventional Principal Component Analysis (PCA) method and an LDA method in accordance with an embodiment of the present invention for comparison;

FIG. 5 shows a method for performing an object recovering process on a marker-free motion captured motion into a 3D graphic in accordance with an embodiment of the present invention;

FIGS. 6 and 7 show motion classification in a 3D game according to the 3D motion applying block of FIG. 1; and

FIG. 8 shows a 3D game in accordance with the embodiment of the present invention.

### BEST MODE FOR THE INVENTION

Other objects and advantages of the present invention will become apparent from the following description of the embodiments with reference to the accompanying drawings. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

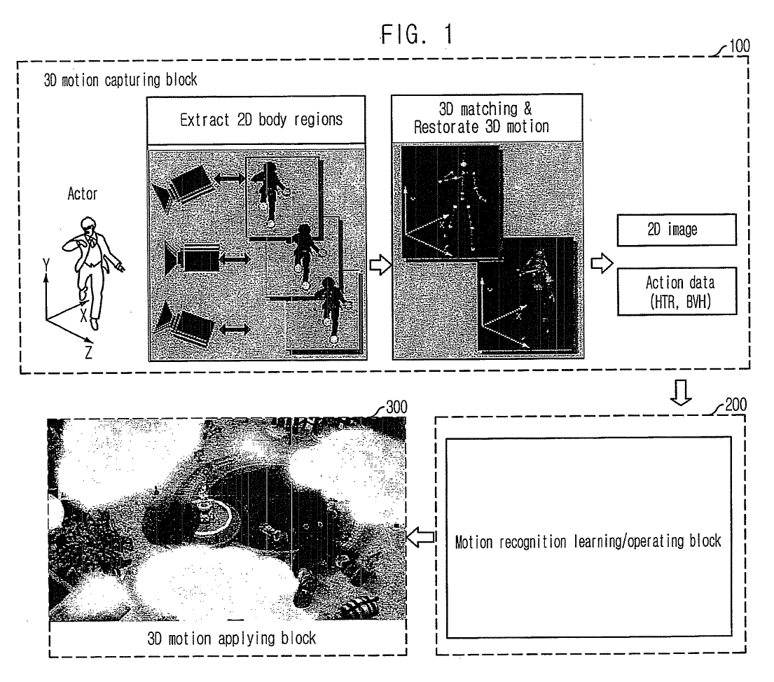

FIG. 1 shows an apparatus for recognizing a three-dimensional (3D) motion using Linear Discriminant Analysis (LDA) in accordance with an embodiment of the present invention.

A method for recognizing the 3D motion using the LDA performed in the apparatus as well as the apparatus for recognizing the 3D motion using the LDA will be described in detail.

As shown in FIG. 1, the apparatus for recognizing the 3D using the LDA includes a 3D motion capturing block 100, a motion recognition learning/operating block 200, and a 3D motion applying block 300. Each constituent element will be described below.

The 3D motion capturing block 100 photographs an actor by using many cameras having different angles and traces a two-dimensional (2D) feature point based on a blob model of a motion feature point extracted from an image of photographed actors who are different from each other.

Subsequently, the 3D motion capturing block 100 performs 3D conformation on the traced 2D feature points, recovers 3D coordinates, estimates a location of a middle joint from the 3D coordinates of the recovered 2D feature points, creates 3D motion data and recovers the created 3D motion data as a human body model.

The 3D motion data according to the present invention includes a series of values notifying location information of the acquired motion based on the marker-free motion capture. A motion data file acquired based on the motion capture is stored in formats of Hierarchical Translation-Rotation (HTR) and BioVision Hierarchy (BVH).

The motion recognition learning/operating block 200 creates a linear discrimination feature component for discriminating corresponding motion data by analyzing motion data on many types of motions created in the 3D motion capturing block 100 by using the LDA and recognizes each of the extracted/stored reference motion features as a corresponding motion by extracting/storing a reference motion feature on each type of motions based on the created linear discrimination feature component.

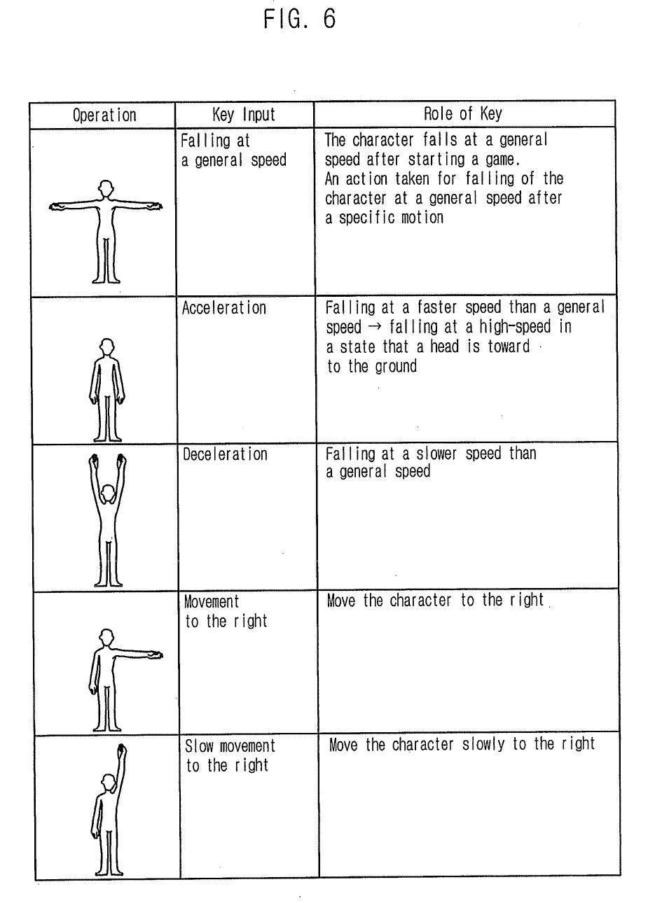

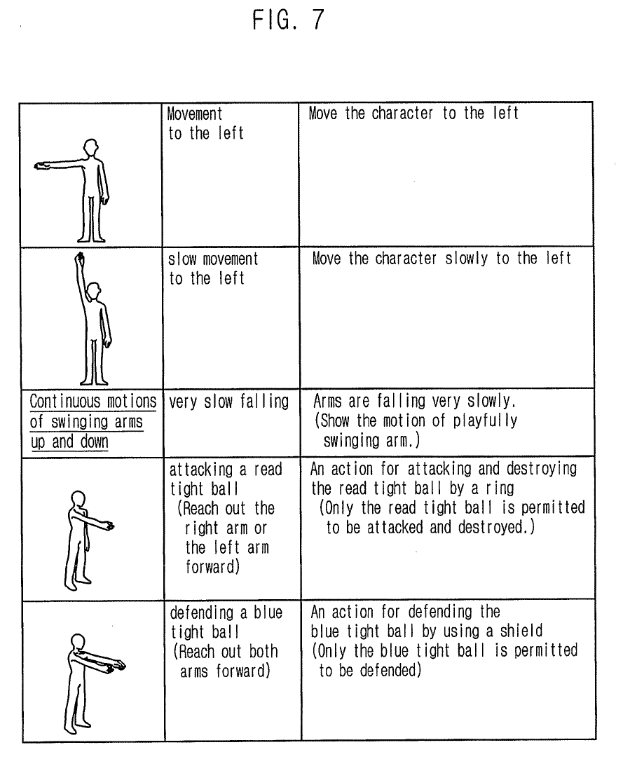

As shown in FIGS. 6 and 7, many types of motions include a 3D motion which can be applied to the 3D motion applying block 300 and the reference motion feature means the motion feature extracted from the motion to be recognized.

Subsequently, the motion recognition learning/operating block 200 extracts a motion feature of motion data on an input motion, which is an object of 3D recognition, created in the 3D motion capturing block 100 based on the linear discrimination feature component, searches a reference motion feature corresponding to the extracted input motion feature among the stored reference motion features, and recognizes the motion corresponding to the searched reference motion feature as the 3D motion on the input motion.

The 3D motion applying block 300 controls a 3D virtual motion of the character by key input corresponding to a motion command transmitted from the motion recognition learning/operating block 200. That is, the 3D motion applying block 300 controls the 3D motion of the character according to a key input value on the 3D motion recognized in the motion recognition learning/operating block 200 and realizes virtual characters of a 3D system, e.g., a 3D game, virtual reality, and a ubiquitous environment, in real-time.

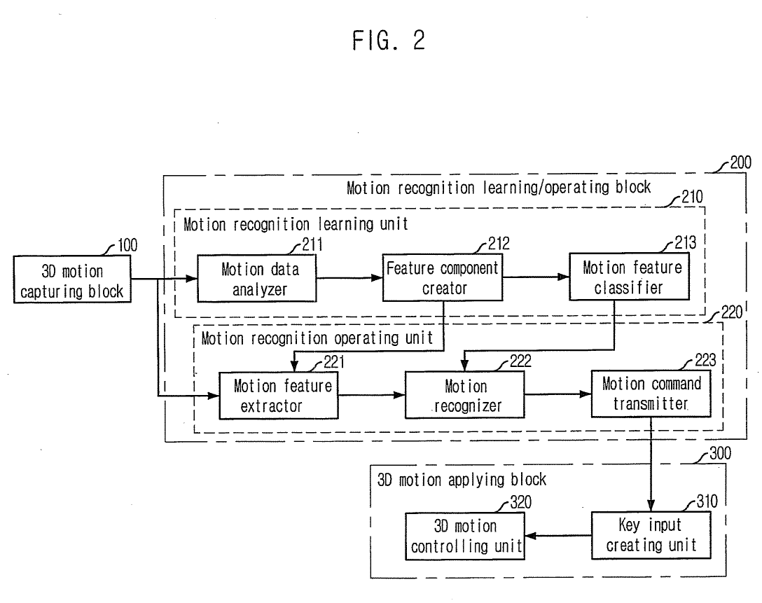

FIG. 2 is a block diagram illustrating the motion recognition learning/operating block and the 3D motion applying block of FIG. 1. Referring to FIG. 2, the motion recognition learning/operating block 200 including a motion recognition learning unit 210 and a motion recognition operating unit 220 will be described hereinafter.

As shown in FIG. 2, the motion recognition learning unit 210 includes a motion data analyzer 211, a feature component creator 212, and a motion feature classifier 213.

The motion recognition learning unit 210 analyzes motion data on many types of motions created in the 3D motion capturing block 100 using the LDA, creates a linear discrimination feature component for discriminating corresponding motion data, extracts/stores a reference motion feature on each type of motions based on the created linear discrimination feature component and recognizes the extracted/stored reference motion feature as a corresponding motion.

Each constituent element will be described in detail hereinafter.

The motion data analyzer 211 analyzes motion data on many types of motions created in the 3D motion capturing block 100 using the LDA. As shown in FIGS. 6 and 7, motions are classified into many types by pre-determining a 3D motion which is applicable to the 3D motion applying block 300.

The feature component creator 212 creates a linear discrimination feature component for discriminating the motion data on many types of motions analyzed in the motion data analyzer 211.

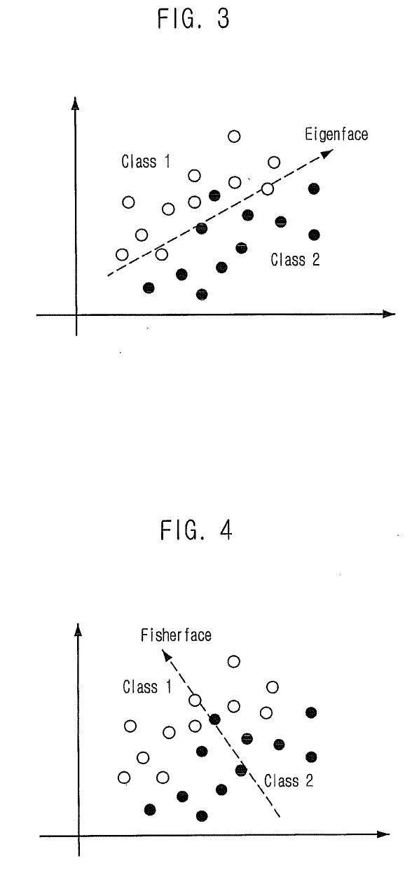

FIGS. 3 and 4 show a conventional Principal Component Analysis (PCA) method and an LDA method in accordance with an embodiment of the present invention for comparison.

The PCA technique and the LDA technique will be described hereinafter with reference to FIGS. 3 and 4.

A feature component according to the present invention is realized according to the LDA technique, which discriminates 3D motion data easier than the PCA method for analyzing a main component of 3D motion data 5 according to each class. Since the PCA technique is a component vector, which is proper to re-realize 3D motion data than discriminating the 3D motion data, the discriminating capability of the PCA technique deteriorates. On the other hand, the LDA technique is a method for creating a component vector, which can be repeatedly divided easily by statistically determining characteristics of each group.

A linear discrimination component vector Wₒₚₜ is shown as Equation 1.

$${W}_{opt} = {\text{arg} max}_{w} \frac{\vert {W}^{T} {S}_{B} W \vert}{\vert {W}^{T} {S}_{W} W \vert} = [ \begin{matrix}{w}_{1} & {w}_{2} & … & {w}_{m}\end{matrix} ] \qquad Eq . 1$$

In the Equation 1, S_{B} is a between-class scatter matrix and S_{W} is a within-class scatter matrix. S_{B} and S_{W} are defined as Equation 2 below.

$${S}_{B} = {\sum }_{i = 1}^{c} {N}_{i} ( {μ}_{i} - \overline{μ} ) {( {μ}_{i} - \overline{μ} )}^{T} \\ {S}_{W} = {\sum }_{i = 1}^{c} {\sum }_{{x}_{k} ∈ {X}_{i}} ( {x}_{k} - {μ}_{i} ) {( {x}_{k} - {μ}_{i} )}^{T} \qquad Eq . 2$$

where Xᵢ is a class of each motion; μᵢ is mean motion data of a motion class Xᵢ; c is the total number of classes and Nᵢ is the number of motion data included in each class.

In Equation 2, the between-class scatter matrix S_{B} shows a method for distributing each class and the within-class scatter matrix S_{W} shows the analysis on how data are distributed in the inside of each class.

In Equations 1 and 2, the linear discrimination component vector Wₒₚₜ of the LDA technique maximizes the ratio of the between-class scatter matrix S_{B} and the within-class scatter matrix S_{W}.

The LDA technique creates a vector for reflecting the values of two classes to different regions and is a method focusing on the discriminating capability.

The motion feature classifier 213 extracts/stores a reference motion feature on each type of motions based on the linear discrimination feature component created in the feature component creator 212 and recognizes the extracted/stored reference motion feature as a corresponding motion.

That is, the motion feature classifier 213 recognized a 3D motion by extracting a 3D motion feature according to each group of the 3D motion data based on the linear discrimination feature component from the 3D motion data on many types of motions, and recognizing the extracted 3D motion feature as a 3D motion to be recognized.

Also, the motion feature classifier 213 divides a motion feature of a human being into a single motion and a combination motion and recognizes a 3D motion feature. Herein, the single motion means a still motion and is a case that the still motion is recognized as one motion. The combination motion is a case that accumulated determination results of continued motions are combined and recognized a single motion.

In case of the combination motion where the continued motions are recognized as a single motion, final recognizing procedures on the combination motion 5 includes the steps of performing final determination process by combining accumulated values and analyzing the combined values within 5 frames. Accordingly, real-time recognition is possible.

As shown in FIG. 2, the motion recognition operating unit 220 includes a motion feature extractor 221, a motion recognizer 222, and a motion command transmitter 223.

The motion recognition operating unit 220 extracts a motion feature based on the linear discrimination feature component created in the motion recognition learning unit 210 from the motion data on an input motion to be an object of 3D recognition created in the 3D motion capturing block 100, searches a reference motion feature corresponding to the extracted input motion feature among the reference motion features stored in the motion recognition learning unit 210, and recognizes a motion corresponding to the searched reference motion feature as a 3D motion corresponding to an input motion.

Each constituent element will be described in detail hereinafter.

The motion feature extractor 221 extracts a motion feature based on the linear discrimination feature component created in the motion recognition learning unit 210 from the motion data on the input motion to be an object of 3D recognition created in the 3D motion capturing block 100.

The motion recognizer 222 measures a statistical distance from the input motion feature extracted from the motion feature extractor 221 among the reference motion features stored in the motion recognition learning unit 210, searches a reference motion feature having the minimum distance, and recognizes a motion corresponding to the searched reference motion feature as the 3D motion of the input motion.

There are many methods for determining in which 3D motion feature group a 3D motion feature value is included when the 3D motion feature value is inputted based on the statistical distance from the 3D motion features. One of the simplest methods is a determining method by distance measurement from a mean value of each group. Also, there are diverse methods such as grasping of characteristics of each group, comparison with a feature value at the edge, or comparing of the numbers of neighboring points.

The method for measuring a statistical distance according to the present invention is a method for measuring a Mahalanobis distance. The Mahalanobis distance f(gₛ) is a method for measuring a distance based on a mean and distribution statistically. An Equation of the Mahalanobis distance f(gₛ) is as shown in Equation 3 below.

f(gₛ)=(gₛ− g̅)^{T}S_{g}⁻¹(gₛ− g̅) Eq. 3

where gₛ is an inputted g̅ sample; is a mean of each group; and S_{g} is a covariance of each group. The Mahalanobis distance f(gₛ) measuring method reflects distribution information of each distribution group on calculation of the distance value as shown in Equation 3 differently from the distance measuring method using only the mean.

The motion command transmitter 223 transmits the 3D motion recognized by the motion recognizer 222 to a motion command of a character.

As shown in FIG. 2, the 3D motion applying block 300 includes a key input creating unit 310 and a 3D motion controlling unit 320. The 3D motion applying block 300 sets up key input on the 3D motion based on the 3D motion recognized in the motion recognition operating unit 220 and controls a 3D virtual motion of the character according to the key input. Each constituent element will be described in detail hereinafter.

The key input creating unit 310 creates key input corresponding to the motion command transmitted from the motion command transmitter 223. That is, differently from the conventional key input creating unit, the key input creating unit 310 according to the present invention creates a key input value including information on a joint of a human body of an actor and a 3D motion as well as a simple key input value while the key input creating unit 310 recognizes the 3D motion and transmits a motion command.

The 3D motion controlling unit 320 receives the key input value created in the key input creating unit 310 and controls the 3D virtual motion of the character according to the key input value.

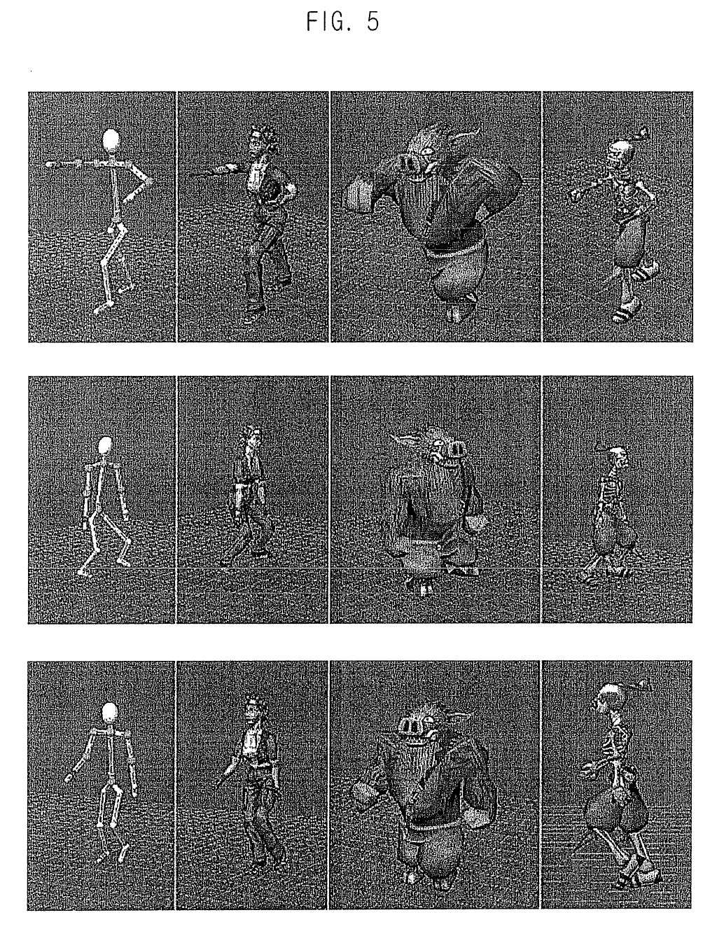

FIG. 5 shows a method for performing an object recovering process on a marker-free motion captured motion into a 3D graphic in accordance with an embodiment of the present invention.

The 3D motion controlling unit 320 not only controls the 3D virtual motion of the character according to the key input value, but also recovers the 3D virtual motion of the character according to a joint model of the recovered 3D human body based on the motion data created in the 3D motion capturing block 100 as shown in FIG. 5.

A method for recognizing a 3D motion using the LDA will be described hereinafter.

The 3D motion capturing block 100 creates motion data for every input motion by performing the marker-free motion capturing process on the motion, which is an object of 3D recognition. The 3D motion capturing block 100 stores a large amount of motion data for every motion in many types of motions, as shown in FIGS. 6 and 7, to be applied in the 3D motion applying block 300 from a user.

Subsequently, the motion recognition operating unit 220 extracts a motion feature based on the pre-stored linear discrimination feature component from the motion data of the input motion, which is a 3D pre-stored recognition object. Herein, the linear discrimination feature component is a vector for discriminating each motion data.

The motion recognition operating unit 220 extracts an input motion feature, measures a statistical distance between the extracted input motion features among the pre-stored reference motion features, and searches a reference motion feature having the minimum distance. The distance between the pre-stored reference motion feature and the input motion feature can be measured by measuring the Mahalanobis distance statistically using the mean and the distribution.

Subsequently, the motion recognition operating unit 220 recognizes a motion corresponding to the searched reference motion feature as a 3D motion of the input motion in the motion feature extracting procedure. When the motion command is transmitted according to the recognized 3D motion, the 3D motion applying block 300 applies the motion data and the motion command to the 3D system.

The present invention analyzes the accumulated values of the recognized 3D motion, divides the 3D motion into a single motion, i.e., a still motion, and a combination motion, i.e., a continuously generated motion, and recognizes the 3D motion. Also, the present invention forms key input corresponding to the recognized 3D motion and controls the 3D virtual motion of the character according to the key input.

Another embodiment will be described hereinafter.

The 3D motion capturing block 100 creates motion data every input motion by performing a marker-free motion capturing process on a motion, which is an object of 3D recognition. As shown in FIGS. 6 and 7, the 3D motion capturing block 100 creates a large amount of motion data for every motion on many types of motions to be applied in the 3D motion applying block 300 from the user.

The motion recognition learning unit 210 analyzes the motion data on many types of motions created in the motion data creating procedure using the LDA, creates a linear discrimination feature component for discriminating corresponding motion data, and extracts/stores a reference motion feature on each type of motions based on the created linear discrimination feature component.

The motion recognition learning unit 210 recognizes each of the extracted/stored reference motion features as a corresponding motion and recognizes the extracted/stored reference motion feature as a single motion, i.e., a still motion, or a combination motion, i.e., a motion combining determination results of the continued motions.

In FIGS. 6 and 7, when the reference motion feature on many types of motions is stored and a procedure of learning many types of motions is performed, the motion data on the input motion are created from the input motion, which is an object of 3D recognition.

Subsequently, the motion recognition operating unit 220 extracts a motion feature based on the linear discrimination feature component created in the feature component creating procedure from the motion data on the input motion, which is an object of 3D recognition.

Herein, the linear discrimination feature component is a vector for discriminating each motion data.

The motion recognition operating unit 220 extracts an input motion features, measures a statistical distance between the extracted input motion features among the reference motion features stored in the motion recognition learning unit 210, and searches a reference motion feature having the minimum distance.

A distance between the reference motion feature and the input motion feature is measured by measuring a Mahalanobis distance statistically using the mean and the distribution.

The motion recognition operating unit 220 recognizes a motion corresponding to the searched reference motion feature as a 3D motion on the input motion in the motion feature extracting procedure. When the motion command is transmitted according to the recognized 3D motion, the 3D motion applying block 300 applies the motion data and the motion command to the 3D system.

Also, the present invention analyzes the accumulated values of the recognized 3D motion, divides the 3D motion into a single motion, i.e., a still motion, and a combination motion, i.e., continuously generated motions, and recognizes the 3D motion. Also, the present invention forms key input corresponding to the recognized 3D motion and controls the 3D virtual motion of the character according to the key input.

FIGS. 6 and 7 show motion classification in a 3D game according to the 3D motion applying block of FIG. 1. FIGS. 6 and 7 show a key input value and key functions on user motions in a 3D application game and shows a recognition type of the 3D motion as well as the conventional 2D motion, which is applicable to the 3D game. As an example of the continuous motion, a motion of swinging arms up and down is included in a range of the recognizable 3D motion.

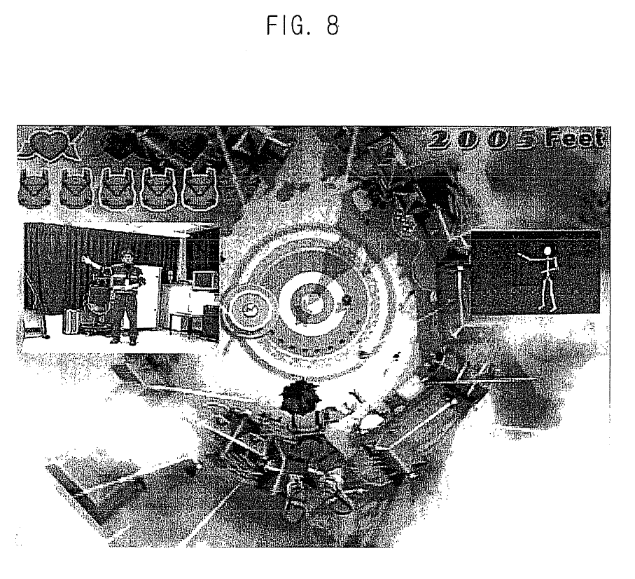

FIG. 8 shows a 3D game in accordance with the embodiment of the present invention. FIG. 8 shows joint data recovered by an actor and a marker-free motion capture system, and a case of performing a motion recognition process based on the recovered joint data and applying the motion recognition to the 3D system in accordance with the embodiment of the present invention. The produced 3D game is a parachute game and has a function that a game character takes a motion, which is similar to the motion of the actor, based on the marker-free motion capture while the game character is falling. The produced 3D game is a game for performing a 3D motion command on a motion to be recognized.

The 3D game applying the 3D motion recognizing apparatus according to the present invention has contents that the character moves to a left or a right while the character is falling, picks up the parachute of the pre-determined numeric character before arriving on the ground, and safely falls down on the ground by avoiding a ball attacking the character from the ground.

The 3D game system according to the present invention has a sequential structure of performing the marker-free capturing process on the motion of the human being in real-time, recognizes the captured motion, and transmits the recognized result to an application program.

Also, the present invention has a 3D motion recognition rate of 95.87% and can recognize more than 30 frames at a second. The 3D game according to the present invention has a function of excluding a motion of a frame where an error progressing differently from the sequential relationship is generated.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

What is claimed is:

1. An apparatus for recognizing a three-dimensional (3D) motion using Linear Discriminant Analysis (LDA), comprising:
a 3D motion capturing means for creating motion data for every motion by using a marker-free motion capturing process for a motion of an actor;
a motion recognition learning means for analyzing the created motion data on multiple types of motions using the LDA, creating a linear discrimination feature component for discriminating corresponding motion data, extracting/storing a reference motion feature on each type of motions based on the created linear discrimination feature component, and recognizing each of the extracted/stored reference motion features as a corresponding motion; and
a motion recognition operating means for extracting a motion feature based on the created linear discrimination feature component from motion data on an input motion to be the created 3D recognition object, searching a reference motion feature corresponding to the extracted input motion feature among the stored reference motion features, and recognizing a motion corresponding to the searched reference motion feature as a 3D motion on the input motion.

2. The apparatus as recited in claim 1, further comprising:
a motion command transmitting means for transmitting the recognized 3D motion to a motion command of a character;
a key input creating means for creating a key input value corresponding to the transmitted motion command transmitted from the motion command transmitting means; and
a 3D virtual motion controlling means for controlling a 3D virtual motion of the character according to the created key input value.

3. The apparatus as recited in claim 1, wherein the motion recognition learning means includes:
a motion data analyzing means for analyzing the created motion data on multiple types of motions using the LDA;
a feature component creating means for creating a linear discrimination feature component for discriminating the analyzed motion data obtained in the motion data analyzing means; and
a motion feature learning means for extracting/storing a reference motion feature on each type of motions based on the created linear discrimination feature component and recognizing each of the extracted/stored reference motion features as a corresponding motion.

4. The apparatus as recited in claim 3, wherein the feature component creating means creates a linear discrimination feature component Wₒₚₜ according to the LDA method using Equations 1 and 2 below;
$${W}_{opt} = {\text{arg} max}_{w} \frac{\vert {W}^{T} {S}_{B} W \vert}{\vert {W}^{T} {S}_{W} W \vert} = [ \begin{matrix}{w}_{1} & {w}_{2} & … & {w}_{m}\end{matrix} ] \qquad Eq . 1$$
$${S}_{B} = {\sum }_{i = 1}^{c} {N}_{i} ( {μ}_{i} - \overline{μ} ) {( {μ}_{i} - \overline{μ} )}^{T} \\ {S}_{W} = {\sum }_{i = 1}^{c} {\sum }_{{x}_{k} ∈ {X}_{i}} ( {x}_{k} - {μ}_{i} ) {( {x}_{k} - {μ}_{i} )}^{T} \qquad Eq . 2$$
where, S_{B} is a between-class scatter matrix; S_{W} is a within-class scatter matrix; Xᵢ is a class of each motion; μᵢ is mean motion data of the motion class Xᵢ; c is the total number of classes; and Nᵢ is the number of motion data included in each class.

5. The apparatus as recited in claim 3, wherein the motion feature learning means recognizes the motion on the extracted/stored reference feature as a single motion, which is a still motion, or a combination motion, which is a motion combining determination results of the continued motions.

6. The apparatus as recited in claim 1, wherein the motion recognition operating means includes:
a motion feature extracting means for extracting a motion feature based on the linear discrimination feature component created in the motion feature extracting means from the motion data on an input motion, which is an object of the 3D recognition object which is generated in the 3D motion capturing means; and
a motion recognizing means for searching a reference motion feature at the minimum statistical distance from the extracted input motion feature extracted in the motion feature extracting means among the stored reference motion features and recognizing a motion corresponding to the searched reference motion feature as the 3D motion on the input motion.

7. The apparatus as recited in claim 6, wherein the statistical distance between the input motion feature and the reference motion feature is measured in the motion recognizing means, is according to a Mahalanobis distance f(gₛ) measuring method using Equation 3 below;
f(gₛ)=(gₛ− g̅)^{T}S_{g}⁻¹(gₛ− g̅) Eq. 3
where gₛ is an inputted sample; g̅ is a mean of each group; and S_{g} is a covariance of each group.

8. A method for recognizing a three-dimensional (3D) motion using Linear Discriminant Analysis (LDA), comprising the steps of:
a) creating motion data for every motion by performing a marker-free motion capturing process on a motion of an actor;
b) extracting a motion feature based on a pre-stored linear discrimination feature component from motion data on an input motion, which is an object of 3D recognition created in the step a);
c) searching a reference motion feature, which has the minimum statistical distance from the extracted input motion feature, among the pre-stored reference motion features; and
d) recognizing a motion corresponding to the searched reference motion feature as a 3D motion corresponding to the input motion.

9. The method as recited in claim 8, further comprising the steps of:
e) creating and storing the linear discrimination feature component for discriminating the motion data by analyzing the created motion data on multiple motions using the LDA;
f) extracting and storing a reference motion feature on each type of motions based on the created linear discrimination feature component generated in the step e); and
g) recognizing each of extracted/stored reference motion features as a corresponding motion.

10. The method as recited in claim 8, further comprising the steps of:
h) transmitting the 3D motion recognized in the step
d) to a motion command of a character;
i) creating a key input value corresponding to the transmitted motion command; and
j) controlling a 3D virtual motion of the character according to the created key input value.

11. The method as recited in claim 10, wherein in the step g), the 3D motion feature is recognized as a single motion, which is a still motion, or a combination motion, which is a motion combining determination results of the continued motions.

12. The method as recited in claim 10, wherein in the statistical distance measuring procedure of the step c), the statistical distance between the input motion feature and the reference motion feature is measured according to a Mahalanobis distance f(gₛ) measuring method using Equation 4 below;
f(gₛ)=(gₛ− g̅)^{T}S_{g}⁻¹(gₛ− g̅) Eq. 4
Where gₛ is an inputted sample; g̅ is a mean of each group; and S_{g} is a covariance of each group.
